(19) United States
(12) Patent Application Publication
(10) Pub. No.: US 2026/0036161 A1
(43) Pub. Date: Feb. 5, 2026

(54) FEMALE COUPLING ELEMENT OF A TWO-PART PLUG-IN COUPLING AS WELL AS A TWO-PART PLUG-IN COUPLING, A COMPONENT, A COMPONENT STRUCTURE AND A CONNECTION METHOD WITH THE FEMALE COUPLING ELEMENT

(71) Applicant: Böllhoff Verbindungstechnik GmbH, Bielefeld (DE)

(72) Inventors: Alexander VORDERWISCH, Bielefeld (DE); Sandra STEFFENFAUSEWEH, Verl (DE); Siegmund SCHLÜTER, Oerlinghausen (DE); Patrick STRICKER, Bielefeld (DE)

(21) Appl. No.: 19/290,008

(22) Filed: Aug. 4, 2025

(30) Foreign Application Priority Data
Aug. 5, 2024 (EP) 24192804.3

(51) Int. Cl. F16C 11/06

(52) U.S. Cl. CPC F16C 11/0657; F16C 11/0666

(57) ABSTRACT

female coupling element (FCE) for relcasably connecting comprising: a polygonal, outer, flange-like attachment structure extending in circumferential direction at an open, first axial end and a dome-like retaining structure (with a polygonal outside having, in circumferential direction, a number of outwardly directed first protrusions and recesses, wherein the retaining structure is axially spaced from the attachment structure by means of a wall extending in a longitudinal direction of the coupling clement and circumferentially as well as inside of the FCE adjacent to the open first axial end, in circumferential direction a plurality of inwardly directed second protrusions and recesses, wherein with respect to a central longitudinal axis, the second protrusions are aligned to the first protrusions, and they comprise an axial extension such that the wall at the second protrusions is thicker than at the second recesses, a material of the FCE being compressible in circumferential direction in the portion of the first and the second recesses, so that during insertion, a male coupling clement's with a shaft causes a radially outwards directed deformation of the FCE in the portion of the first and second protrusions.

### 1. FIELD OF THE INVENTION

The present invention relates to a female coupling element of a two-part plug-in coupling for releasably connecting a first component with polygonal component opening and a second component, a two-part plug-in coupling with the female coupling element, a first component with a polygonal component opening and the female coupling element, a component structure made of the first component with a polygonal component opening and the female coupling element as well as a second component and a connection method.

### 2. BACKGROUND OF THE INVENTION

A plurality of plug-in couplings with snap connection between a spherical head and a spherical socket are known in the state of the art. The component with the spherical socket represents a female coupling element while the component with the spherical head or ball head represents a male coupling element. Two components can be connected releasably with one another via the releasable connection between female and male coupling element.

For this purpose, a first component normally comprises a round component opening. The female coupling element is inserted into this opening. In order to fasten the female coupling element in the round component opening, the female coupling element comprises a circumferential flange as well as protrusions at its outside. When inserting the female coupling element into the component opening, the protrusions are pushed radially to the inside and after passing the component opening, they spring radially to the outside. In this state, the female coupling element is completely mounted. This means that the female coupling element is now already capable of withstanding the forces which the connection will later have to withstand via the plug-in coupling. For this purpose, a tool to insert the female coupling element is necessary in order to raise the forces which are necessary to insert such a female coupling element into the component opening.

An example for such a plug-in coupling can be found in DE 2016 216 07 949 U1. The plug-in coupling for releasably connecting a first component with a second component comprises an elastically deformable socket-like coupling part with a fastening section defined at the first component and a spherical socket formed to it. Furthermore, the plug-in coupling comprises an elastically deformable spherical coupling part with a fastening section defined at the second component, a spherical head which may be snapped in the spherical socket and an intermediate section placed between the fastening section and the spherical head. The spherical socket of the socket-like coupling part is provided with a number of recesses which are provided at its outside and distributed in circumferential direction.

A spherical bowl with a base body is described in DE 10 201 022 A1. The base body comprises a recess for receiving a joint head which is in particular spherical. The recess is shaped so that it encompasses the joint head at least partly after being inserted into the recess. Furthermore, the spherical bowl comprises at least one latching element.

A disadvantage of these known arrangements is that due to the forces which need to be applied, an assembly of the female coupling element into the component opening is only possible with a tool. Furthermore, it is disadvantageous that the plug-in couplings are adapted to round component openings as by that, they are not or only poorly usable in connection with a polygonal component opening.

Therefore, it is the object of the present invention to create a plug-in coupling with which the female coupling element is insertable into a polygonal component opening in the first component with reduced insertion forces in comparison with the state of the art, while when in use it implements the forces provided by the known plug-in couplings when connecting two components.

### 3. SUMMARY OF THE INVENTION

The above object is solved by a female coupling element of a two-part plug-in coupling for releasably connecting a first component with polygonal component opening and a second component according to the independent claim 1, a two-part plug-in coupling with the female coupling clement according to claim 8, a first component with a polygonal component opening and the female coupling element according to claim 11, a component structure comprised of the first component with a polygonal component opening and the female coupling element as well as a second component according to claim 13 and a connection method according to claim 15. Advantageous embodiments and further developments arise from the subsequent description, the drawings as well as the appending claims.

An inventive, female coupling element of a two-part plug-in coupling for releasably connecting a first component with polygonal component opening and a second component comprises the following features: a polygonal, outer, flange-like attachment structure extending in circumferential direction at an open, first axial end as well as a dome-like retaining structure with a polygonal outside having in circumferential direction a number of outwardly directed first protrusions and recesses being alternately arranged, wherein the retaining structure is axially spaced from the attachment structure by means of a wall extending in a longitudinal direction of the coupling element as well as circumferentially, and inside of the female coupling element adjacent to the open first axial end in circumferential direction a plurality of inwardly directed second protrusions and recesses being alternately arranged, wherein with respect to a central longitudinal axis of the female coupling element, the second protrusions are aligned to the first protrusions, and the second protrusions comprise an axial extension of a kind that the wall in the portion of the second protrusions is thicker in comparison with the portion at the second recesses, so that when inserting the female coupling element into the polygonal component opening, a material of the female coupling element is elastically compressible in circumferential direction in the portion of the first and the second recesses, so that an axial insertion force for preassembling the female coupling element in the polygonal component opening of the first component is reduced, and when inserting a male coupling element with a shaft and a spherical head, the, the shaft of the male coupling element causes a radially outwards directed deformation movement of the female coupling element in the portion of the first and second protrusions which are aligned to one another.

In the following, the inventive female coupling element is described with regard to its use for the better comprehensibility of the functionality. In this context, it is preferred that the female coupling clement is made of one of the following materials or a combination of them: polypropylene, silicone and/or EPDM. By selecting the suitable material, the female coupling element can be adapted to the respective application casc.

A releasable connection of a first component with the polygonal component opening and a second component is supposed to be realized with the female coupling element. For this purpose, a male coupling element with a shaft and a spherical head is necessary apart from the first and the second component, which are separated by means of a tapering arranged there between. The male coupling element can be formed integrally at the second component or connected with same.

In a first step, the female coupling element is inserted into the polygonal component opening of the first component. As an example, the polygonal component opening is a rectangular opening with rounded corners. A diagonal de of the component opening is for example 20 mm. As is explained later, in this case, an outer diagonal Dw of the wall lies between 18.0 mm and 18.3 mm. Due to this dimensioning, there is a gap b between the component opening and the wall of the female coupling element at least in the portion of the rounded corners. When the first protrusions are for example provided in the portion of the rounded corners as well, they do, however, extend beyond the component opening, which will be explained later by means of exemplary dimensionings.

Due to the design and in particular the alignment of the first and the second protrusions and thus also of the first and second recesses to one another, it is possible to insert the female coupling element into the component opening without using a tool, as due to the first and second recesses which are aligned in axial direction with each other and thus to one another, i.e. the recesses on the inside and the outside, the female coupling element can be compressed elastically. By that, the inserting of the female coupling element into the polygonal component opening of the first component is facilitated.

As soon as the first component or the first protrusions, respectively, have passed the polygonal component opening, they extend elastically to the outside. In doing so, a distance between the wall of the female coupling element and an inner wall of the component opening is to be dimensioned so that there is at least a radial leeway or a gap, as was shown above based on the exemplary dimensioning. This radial leeway or this gap, respectively, is in particular present in the portions with the recesses, should the component already abut the portions with the recesses on the outside, i.e. with the first recesses. In this context, it is preferred that the wall is configured circumferentially closed.

That way, the female coupling element is thus preassembled in the first component. The term “preassembled” means that the female coupling element is not yet finally fastened. Rather, it is only arranged in the component opening in a way that generally, a loss proof security for the female coupling element is provided in the first component. In this state, the wall of the coupling element which extends parallel to the central longitudinal axis is preferably only present in the sections without first protrusions, i.e. in the portion of the first recesses, and not in the portion of the first protrusions at the component opening.

A safe fastening of the female coupling element in the first component and thus a properly functioning plug-in coupling, i.e. a releasable connection between the components, is only realized by means of inserting the male coupling element into the female coupling element. For this purpose, the female coupling element particularly comprises a spherical socket like receptable adjacent to the second axial end. In this context, it is particularly preferred that in the direction of the first axial end, adjacent to the spherical socket like receptable, there is a circumferentially extending protrusion projecting to the inside, which is configured preferably completely circumferentially.

The corresponding male coupling element is designed in a way that the shaft of the male coupling element has an outer diameter Ds corresponding to at least the outer diameter DK of the spherical head. For example, the value for both outer diameters is 10 mm. Accordingly, the spherical socket like receptable also has a diameter of 10 mm. The circumferentially formed protrusion projecting to the inside interacts with the tapering of the male coupling element when the male coupling element is in the inserted state.

The second protrusions project appropriately far to the inside so that when inserted into the female coupling element, the shaft of the male coupling element causes a radially outward directed movement of the female coupling element in the portion of the second projections on the inside of the female coupling element. The corresponding dimensionings, particularly with regard to an inner diagonal di in the portion of the second protrusions, will also be discussed later.

As the second protrusions on the inside are aligned with the first protrusions on the outside, the female coupling element is pushed radially to the outside in this portion. By that, the first protrusions are moved radially outwards on the outside, so that a proper fastening of the female coupling element in the first component is provided in connection with the releasable plug-in connection.

Thus, the forces for removing the female coupling element from the component opening in the first component with inserted male coupling element are higher than compared with the arrangement without male coupling element, i.e. compared to the pre-assembled state. Furthermore, in this state, the wall of the female coupling element which extends parallel to the central longitudinal axis abuts the component opening preferably completely, i.e. also in the portion of the first protrusions.

Preferably, it is possible that due to the specific design of the female coupling element, same is inserted into the first component with a force of ≤50 N, with the female coupling element being made of a material having a Shore A hardness of less than 70 at room temperature. As regards determining the Shore A hardness, reference is made to DIN ISO 7619-1 as well as to DIN EN ISO 868.

As initially explained, the provided first and second recesses enable a compressing, e.g. in the form of a folding, of the female coupling element during the assembly. In other words, the first and second recesses are thin sections in the material of the female coupling element. Particularly due to these recesses and the compressing of the female coupling element, the undercuts created by the first protrusions on the outside, which in case of other couplings must be pushed through the receptable by applying force, are smaller and preferably located within the polygonal component opening. Thus, lower assembly forces are generated when assembling the female coupling element in the first component.

The female coupling element is used with a correspondingly designed male coupling element so that it cannot be pushed out of the polygonal component opening due to the smaller undercuts. This has already been described above.

The resulting assembling and disassembling forces of the male coupling element into and out from the female coupling element lie in the range of those plug-in couplings known from the state of the art. However, the interaction between male and female coupling element is different in that the male coupling element spreads open and secures the female coupling element in connection with the inventive plug-in coupling, instead of the female coupling element being fastened by means of clamping in the first component and without the male coupling element having an influence on securing the female coupling element in the component opening, but for example having a radial leeway with respect to the female coupling element in the shaft portion, as is the case with the arrangements known from the state of the art.

Therefore, it is advantageous that the inventive, female coupling element is usable in combination with a polygonal component opening instead of a cylindrical component opening and the forces for preassembling the female coupling element are lower compared to the known female coupling elements. Nonetheless, the retention forces which are necessary for the known plug-in couplings are achieved when using the corresponding male coupling element.

In a preferred embodiment of the female coupling element, the attachment structure and/or the retaining structure comprises three, four, five or six corners, which in particular are rounded.

Due to the design of the retaining structure analogous to the polygonal component opening, the female coupling element can be pre-oriented in the component opening. The design of the attachment structure analogous to the polygonal component opening allows the attachment structure to lie around the component opening in a planar manner and to completely cover the opening and thus to be able to seal same, too.

It is furthermore preferred that the first protrusions are provided on the outside in each corner of the polygonal form or on each lateral face of the polygonal form. In the course of this configuration, it is particularly advantageous that every first protrusion that is arranged in every corner is attributed to a second protrusion on the inside or that each first protrusion arranged on a lateral surface is attributed to a second protrusion. By providing the first protrusion either in each corner of the polygonal form or on each lateral surface, the female coupling element can be adapted perfectly to the respective application case. In this context, the configuration in which two protrusions are provided analogously to the first protrusions is particularly preferred. That way in particular, an inserting of a corresponding male coupling element causes the first protrusion to be moved radially far enough to the outside that the connection which is established by the plug-in coupling provides the necessary pull-out forces.

In a further preferred embodiment of the female coupling element, every other protrusion, i.e. cach protrusion on the inside, has an insertion slope enclosing an angle with the central longitudinal axis of the coupling element between 10° and 40°. The advantage of providing an insertion slope is that the force is led to the outside and not to the top in the direction of the second axial end. By that, it can be guaranteed particularly effectively that the female coupling element is not pushed further into the component opening and in the most unfavorable case pushed through the component opening.

Advantageously, a relation of an outer diagonal DA in the portion of the first protrusions to an outer diagonal D_{W} in the portion of the wall is 1.15 D_{W}≤D_{A}≤1.2 D_{W} when two first protrusions are arranged on opposite corners. Particularly with regard to the use in connection with the component opening, the relation of the outer diagonal D_{A} in the portion of the first protrusions to the outer diagonal D_{W} in the portion of the wall should be considered.

Based on the above example where the diagonal D_{B} for the component opening was 20 mm, the diagonal D_{W} in the portion of the wall lies between 18.0 mm and 18.3 mm. For reasons of comprehensibility, a diagonal D_{W} with 18.3 mm is assumed. The overall distance present in the portion of the wall is then 1.7 mm so that with a centrally arranged female coupling element, there is a gap b of 0.85 mm at two diagonally opposed corners.

Therefore, the diagonal D_{A} in the portion of the first protrusions lies between 21.045 mm and 21.96 mm. From that, an overall projection in the portion of the first protrusions of 1.045 to 1.96 mm arises. A projection z for a first protrusion each on the first component therefore lies between 0.5225 mm and 0.98 mm. This emphasizes the low coverage of the first protrusions with the first component in the course of the pre-assembly.

An inventive two-part plug-in coupling comprises an inventive female coupling element as well as a male coupling element having a shaft and a spherical head, which are separated by means of a tapering arranged there between. In the course of the inventive plug-in coupling, the inventive female coupling element is therefore used. With respect to the advantages arising from that, reference is made to the above explanations.

In a preferred embodiment of the two-part plug-in coupling, an outer diameter D_{S} of the shaft is the same or larger than an outer diameter D_{K} of the spherical head, so that the following applies: D_{S}≥D_{K}. As already mentioned in the beginning, particularly the diameter of the shaft of the male coupling element under consideration of the diameter of the spherical head of the male coupling element is important, as with the shaft, the gap in the portion of the first projections is reduced.

Advantageously, the following applies to an outer diameter D_{S} of the shaft with respect to an inner diagonal di in the portion of two second protrusions which are arranged opposite one another: 1.1 d_{I}≤D_{S}≤1.26 D_{I}. Due to this relation, the inner diameter dr in the portion of the second protrusions is always smaller than the outer diameter D_{S} of the shaft of the male coupling element. By that, a particularly effective pushing of the female coupling element radially to the outside in the portion of the first and second protrusions is realized.

In this context, the relation of overlapping a to gap b can additionally or alternatively be considered, with the following preferably applying: 0.6 b≤a≤1.3 b.

Here, it is of particular advantage when the male coupling element in the completely coupled state pushes the female coupling element above the first component radially to the outside. Particularly by that, the high force for disassembling the male coupling element out from the female coupling element is generated and the female coupling element is not pulled out from the component.

An inventive first component comprises a polygonal component opening in which an inventive female coupling element is preassembled. In a preferred embodiment of the first component, the following applies to an inner diagonal dp of the component opening with respect to an outer diagonal D_{W} of the wall: 1.09 D_{W}≤d_{B}≤1.11 D_{W}. With reference to the above example, an exemplary inner diagonal dp for the component opening with 20 mm was assumed. In the portion of the wall, the outer diagonal D_{W} is 18.3 mm with the relation d_{B}=1.09D_{W}.

In the course of the inventive first component, the inventive female coupling element is used, so that reference is made to the above explanations. It is particularly the here selected proportionality of the inner diagonal d_{B} of the component opening with respect to an outer diagonal D_{W} of the wall which guarantees the particularly advantageous, above explained functionality, i.e. the manual pushing-in without tool for preassembling the female coupling element as well as the subsequent locking after inserting the male coupling element.

An inventive component structure is made of the inventive first component as well as a second component with male coupling element having a shaft and a spherical head, which are separated by means of a tapering arranged in between, the spherical head being arranged at least partly in the spherical socket like receptable. According to an advantageous embodiment of the component structure, in case of a central arrangement of the female coupling element in the component opening of the first component, the following applies to the outer diameter D_{S} of the shaft with respect to a gap b, which is present between the wall of the female coupling element in the portion of the first protrusions and the component opening in a non-assembled state of the male coupling element: 11 b≤D_{B}≤15.6 b.

A value of 10 mm as outer diameter D_{S} was assumed above. Based on the above relation, the gap b must lie between 0.6 mm and 0.9 mm. In the example used in the beginning, a gap b of 0.85 mm was assumed, which in case of the shaft diameter D_{S} of 10 mm leads to the relation D_{S}=11.76 b.

Here as well, reference is made to the above explanations in order to avoid repetitions, as the inventive component structure uses the inventive plug-in coupling or the inventive first component, respectively, in connection with a male coupling element. Based on the above proportionalities, the additional proportionality of the gap with respect to the outer diameters of the shaft is carried out, as by that, it can be guaranteed particularly effectively that the female coupling element is arranged in a sealing manner in the first component when the male coupling element is inserted.

An inventive connecting method of a first component with a polygonal component opening with a second component by means of an inventive two-part plug-in coupling comprises the following steps: providing the female coupling element and inserting the female coupling element into the polygonal component opening of the first component or providing the first component with female coupling element pre-assembled in there, providing a second component with male coupling element having a shaft and a spherical head which are separated by means of a tapering arranged in between, and inserting the spherical head into the female coupling element until the spherical head is arranged at least partly in a spherical socket like receptable, the shaft causing a radially outwards directed deformation movement of the female coupling element in the portion of the first and the second projections. The inventive connecting method uses the inventive female coupling element. Therefore, in this regard, reference is again made to the above explanations in order to avoid repetitions.

### 4. SHORT SUMMARY OF THE DRAWINGS

In the following, the present invention will be described in detail with respect to the drawings. In the drawings, the same reference signs refer to the same components and/or elements. They show:
FIG. 1 a first perspective view of an embodiment of an inventive female coupling element,
FIG. 2 a second perspective view of an embodiment of an inventive female coupling element,
FIG. 3 a first partial sectional view of the female coupling element according to FIG. 1,
FIG. 4 a second partial sectional view of the female coupling element according to FIG. 1,
FIG. 5 a view of the female coupling element according to FIG. 1 from above,
FIG. 6 a view of the female coupling element according to FIG. 1 from below,
FIG. 7 a sectional view of an embodiment of an inventive component structure,
FIG. 8a a cross-sectional view in the portion of the wall of the female coupling element,
FIG. 8b an enlarged view of a section of FIG. 8a,
FIG. 9 a sectional view of the female coupling element in the first component with inserted male coupling element,
FIG. 10 a first sectional view of the female coupling element in the first component with male coupling element that is not inserted completely,
FIG. 11 a second sectional view of the female coupling element in the first component with male coupling element that is not inserted completely,
FIG. 12 a sectional view of the female coupling element in the first component with male coupling element that is not inserted completely for illustrating the insertion slope and
FIG. 13 a schematic flow chart of an embodiment of an inventive connecting method.

### 5. DETAILED DESCRIPTION OF THE PREFERRED EMBODIMENTS

In the following, an embodiment of the inventive female coupling element 10 is explained with reference to the figures. For this purpose, FIGS. 1 to 6 show the structure of the female coupling element 10, while FIGS. 7 to 12 illustrate the dimensioning as well as the use. Firstly, it should be emphasized in this respect that the female coupling element 10 is preferably formed of one of the following materials or a combination of them: polypropylene, silicone and/or EPDM, because with the suitable choice of material, the female coupling element 10 can be adapted to the respective application case.

The female coupling element 10 has a first 12 as well as a second axial end 14. The first axial end 12 of the female coupling element 10 has an open configuration while the second axial end 14 has a closed configuration.

A polygonal outer flange-like attachment structure 16 extending in circumferential direction is provided at the first axial end 12. In the illustrated embodiment, the attachment structure 16 comprises four corners which are rounded.

Furthermore, there is a dome-like retaining structure 20 with a polygonal outer side. The retaining structure 20 is axially spaced from the attachment structure 16 by means of a wall 18 extending circumferentially and in longitudinal direction of the coupling element 10.

In circumferential direction, the retaining structure comprises a plurality of outwards directed first protrusions 22 and first recesses 24, which are alternately arranged. The retaining structure 20 also comprises four corners. Apart from the configuration with four corners, configurations with three, four, five or six corners, which in particular are rounded, are possible, too.

In the illustrated embodiment, the first protrusions 22 are provided on the outside in each corner of the polygonal form. The outer diagonal in the portion of the first protrusions 22 is referred to with D_{A} and the outer diagonal in the portion of the wall 18 is referred to with D_{W}. The relation of the two outer diagonals to one another will be discussed later when it comes to the use of the female coupling element 10.

Inside of the female coupling element 10, a number of inwards directed second protrusions 26 and recesses 28, arranged in circumferential direction and also arranged in an alternating manner, are provided adjacent to the open first axial end 12. An inner diagonal in the portion of the second protrusions 26 is referred to as d_{I}.

With respect to a central longitudinal axis L of the female coupling element 10, the second protrusions 26 are aligned to the first protrusions 22. The second protrusions 26 have an axial extension so that the wall 18 in the portion of the second protrusions 26 is thicker in comparison with the portion at the second recesses 28. This can particularly be seen when comparing FIGS. 3 and 4.

Due to this design, a material of the female coupling element 10 in the portion of the first 24 and the second recesses 28 is elastically compressible in circumferential direction when inserting the female coupling element 10 into a polygonal component opening.

Each first protrusion 22 arranged on the outside in each corner is attributed to a second protrusion 26 on the inside. Particularly with this arrangement of the first 22 and second protrusions 26 to one another, an inserting of a corresponding male coupling element 40 leads to the first protrusions 22 being radially moved to the outside far enough that the connection which is established via the plug-in coupling provides the necessary pull-out forces.

Alternatively to the illustrated embodiment, the first protrusions 22 can be provided on the outside on each lateral side of the polygonal form. In this case, it is preferred that a second protrusion 26 is assigned to each first protrusion 22 that is arranged on a lateral face. Assigning takes place in an analogous manner so that the second protrusions 26 are provided radially inside in alignment with the first protrusions 22.

Each second protrusion 26 comprises an insertion slope 30 on the inside. It encloses an angle a with the central longitudinal axis L of the female coupling element 10 between 10° and 40° (sec FIG. 12). Providing the insertion slope 30 has the advantage that by that, the force is led to the outside and not to the top in the direction of the second axial end 14. By that, it can be guaranteed particularly effectively that the female coupling element 10 is not pushed further into the component opening and in the worst case pushed through the component opening.

Furthermore, the female coupling element 10 includes a spherical socket like receptable 32 on the inside adjacent to the second axial end 14. In this context, it is particularly preferred that in the direction of the first axial end 12 adjacent to the spherical socket like receptable 32, there is a circumferentially extending, inwards projecting protrusion 34, which is preferably configured in a completely circumferential manner.

The provided first 24 and second recesses 28 therefore provide thin sections in the material of the female coupling element 10 which allow a compressing, e.g. by means of folding together the female coupling element during the assembly. Particularly due to these recesses 24, 28 and the compression of the female coupling element 10, the undercuts which are created by the first protrusions 22 on the outside, and which with other couplings must be pushed through the receptable by applying force, are smaller and preferably located within the polygonal component opening. Therefore, lower assembly forces when assembling the female coupling element 10 in the first component 1 are generated. Only after inserting a suitable male coupling element 40, the proper functionality of the female coupling element 10 is provided. Here, the interaction between male 40 and female coupling element 10 in comparison with known plug-in couplings is different in that the male coupling element 40 spreads open and secures the female coupling clement 10 instead of fastening the female coupling element in the first component 1 by means of clamping and without the male coupling element having any influence on securing the female coupling element in the component opening but instead having, for example, a radial leeway to the female coupling element in the shaft portion, as is the case with the arrangements known from the state of the art.

With reference to FIGS. 7 to 12, the approach as regards establishing a connection between two components 1, 3 is now explained. With the female coupling element 10 designed that way, a releasable connection of a first component 1 with polygonal component opening and a second component 3 can be realized, as shown in FIG. 7.

For this purpose, a male coupling element 40 with shaft 44 and spherical head 42 is necessary beside the first 1 and the second component 3. Spherical head 42 and shaft 44 are separated from one another by means of a tapering 46 arranged in between. In the illustrated embodiment, the male coupling element 40 is integrally configured at the second component 3. Alternatively, it can be firmly connected with the second component 3. An outer diameter of the shaft 44 of the male coupling element 40 is referred to with D_{S} and an outer diameter of the spherical head 42 is referred to with DK.

In order to establish the connection between the first 1 and the second component 3, the female coupling element 10 is inserted into the polygonal component opening of the first component 1 in a first step. In the illustrated embodiment, this is a rectangular component opening with rounded corners. Both the retaining structure 20 as well as the attachment structure 16 and the wall 18 also have a rectangular form with rounded corners. As the retaining structure 20 is therefore designed analogously to the polygonal component opening, the female coupling element 10 can be pre-oriented in the component opening. The design of the attachment structure 16 analogous to the polygonal component opening allows the attachment structure 16 to lie around the component opening in a planar manner and to cover the opening completely and thus, also seal it.

In the illustrated embodiment, an inner diagonal dp of the component opening of 20 mm is assumed as an example. Regarding a relation of the inner diagonal dp of the component opening to the outer diagonal D_{W} of the wall 18, the following applies: 1.09D_{W}≤d_{B}≤1.11 D_{W}. The outer diagonal D_{W} of the wall 18 therefore lies between 18.0 mm and 18.3 mm. In the following, the value 18.3 mm is used for the outer diagonal D_{W} of the wall 18 in order to facilitate comprehensibility.

Due to this dimensioning, there is a gap b between the component opening and the wall 18 of the female coupling element at least in the portion of the rounded corners. In this regard, additional reference is made to FIGS. 8a and 8b which show a cut in the portion of the wall 18 in a plane perpendicular to the longitudinal axis L. The overall distance in the portion of the wall is 1.7 mm so that in case of a centrally arranged female coupling element 10, there is a gap b of 0.85 mm at two corners which face each other diagonally.

With respect to a relation of the outer diagonal D_{A} in the portion of the first protrusions 22, which are arranged opposite one another in the illustrated embodiment, to an outer diagonal Dw in the wall 18, 1.15 D_{W}≤D_{A}≤1.2 D_{W} applies. Based on D_{W}=18.3 mm, the diagonal D_{A} in the portion of the first protrusions therefore lies between 21.045 mm and 21.96 mm. Therefore, an overall projection of 1.045 to 1.96 mm in the portion of the first protrusions arises. A projection z for a first protrusion 22, each, on the first component 1 therefore lies between 0.5225 mm and 0.98 mm. This highlights the low coverage of the first protrusions 22 with the first component 1 during the pre-assembly. For the rest, i.e. in the portion of the first 24 and the second recesses 28, the wall 18 attaches the component opening of the first component 1, as can also be seen in FIGS. 8a and 8b. In this context, it is preferred that the wall 18 is configured circumferentially closed.

Due to the special design of the female coupling element 10, same can be inserted into the component opening without using a tool, as due to the recesses 24, 28 on the inside and on the outside, which are aligned in axial direction to each other and thus facing one another, the coupling element 10 can be elastically compressed at these positions. Besides a bulging, the elastic compression can also be a folding. By that, the inserting of the coupling element 10 into the polygonal component opening 1 of the first component is facilitated.

Preferably, due to the specific design of the female coupling element 10, it is possible to insert same into the first component 1 with a force of ≤ 50 N, with the female coupling element 10 being made of a material having a Shore A hardness at room temperature of less than 70. With regard to determining the Shore A hardness, reference is made to DIN ISO 7619-1 as well as DIN EN ISO 868.

As soon as the first protrusions 22 have passed the polygonal component opening, they extend elastically to the outside and the female coupling element 10 is pre-assembled in the first component 1. The term “pre-assemble” indicates that the female coupling element 10 has not yet been fastened completely. Rather, it is only arranged in the component opening in a manner that principally, a loss-proof security for the female coupling element 10 is provided in the first component 1. In this state, the wall of the female coupling element 10 which extends parallel to the central longitudinal axis L preferably attaches the component opening in the portion of the first recesses 24 only, but not in the portion of the first protrusions 22.

A secure fastening of the female coupling element 10 in the first component 1 and thus a properly functioning plug-in coupling, i.e. a releasable connection between the components 1, 3 is only realized by the inserting of the male coupling element 40 into the female coupling element 10.

The corresponding male coupling element 40 is configured such that the shaft 44 of the male coupling element 40 has an outer diameter D_{S} at least corresponding to the outer diameter D_{K} of the spherical head 42. Accordingly, D_{S}≥D_{K} applies in the illustrated embodiment. An example for a corresponding outer diameter is 10 mm for D_{S} and D_{K}.

Furthermore, 1.1 di≤D_{S}≤1.26 di applies to the outer diameter D_{S} of the shaft 44 with respect to an inner diagonal di in the portion of two second protrusions 46, which are arranged opposite one another. Due to this proportionality, the inner diameter di in the portion of the second protrusions 26 is always smaller than the outer diameter D_{S} of the shaft 44 of the male coupling element 40. By that, a particularly effective pushing of the female coupling element 10 radially to the outside in the portion of the first 22 and the second protrusions 26 is realized. Based on the example with 10 mm for the outer diameter D_{S} of the shaft 44, the inner diagonal di therefore lies in the range between 7.9 mm and 9.1 mm. An overall coverage in cross section of 0.9 to 2.1 mm arises by that. A width of the corresponding overlapping a therefore lies between 0.45 and 1.05 mm.

As the gap b to be closed is 0.85, the choice of an overlapping a in the direction of the upper limits is to be preferred. In this context, the relation of overlapping a to gap b can be considered additionally or alternatively, to which the following preferably applies: 0.6b≤a≤1.3 b. Therefore, the overlapping a should lie between 0.51 and 1.105 mm.

With a central arrangement of the female coupling element 10 in the component opening of the first component 1, 11<b>D_{S}≤15.6 b applies to the outer diameter D_{S} of the shaft 44 with respect to a gap b, which is present between the wall 18 of the female coupling element 10 in the portion of the first projections 22 and the component opening in a non-assembled state of the male coupling element 40. In the beginning, a value of 10 mm was assumed as the outer diameter D_{S}. Thus, a gap b between 0.6 mm and 0.9 mm arises. In the above example, a gap b with 0.85 mm was assumed, which leads to the relation D_{S}=11.76 b.

Due to these relations to one another, an axial insertion force for preassembling the female coupling element 10 in the polygonal component opening of the first component 1 is reduced. It is only an inserting of the male coupling element 40 with a shaft 44 and a spherical head 42 which causes the shaft 44 of the male coupling element 40 to perform a radially outwards directed deformation movement to the female coupling element 10 in the portion where the first 22 and second protrusions 26 are aligned with one another and fixes the female coupling element 10 in the first component 1. As the second protrusions 26 on the inside are aligned with the first protrusions 22 on the outside, the female coupling element 10 is pushed radially to the outside in this portion. By that, the first protrusions 22 are correspondingly pushed radially to the outside which leads to a proper fastening of the female coupling element 10 in the first component 1 with regard to the releasable plug-in connection. Thus, the forces for removing the female coupling clement 10 from the component opening in the first component 1 with inserted male coupling clement 40 are larger compared with the arrangement without male coupling clement 40, i.e. in comparison with the pre-assembled state.

In doing so, it is particularly advantageous that when in the completely coupled state, the male coupling element 40 pushes the female coupling element 10 radially to the outside above the first component 1. The high force for disassembling the male coupling clement 40 from the female coupling element 10 is particularly generated by that and the female coupling element 10 is not pulled out from the first component 1.

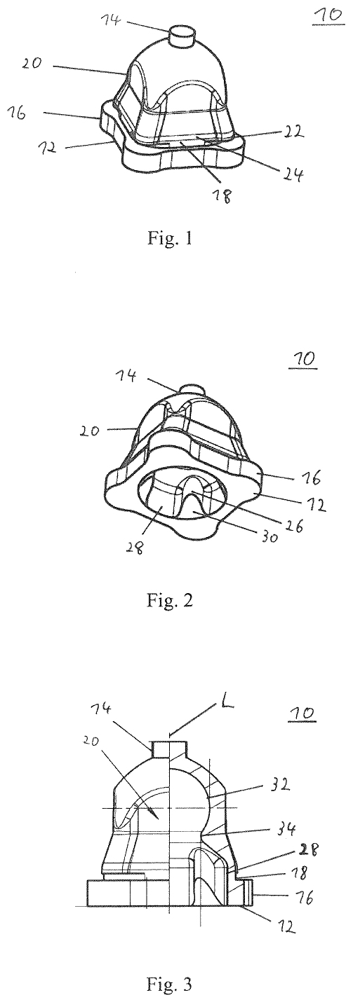

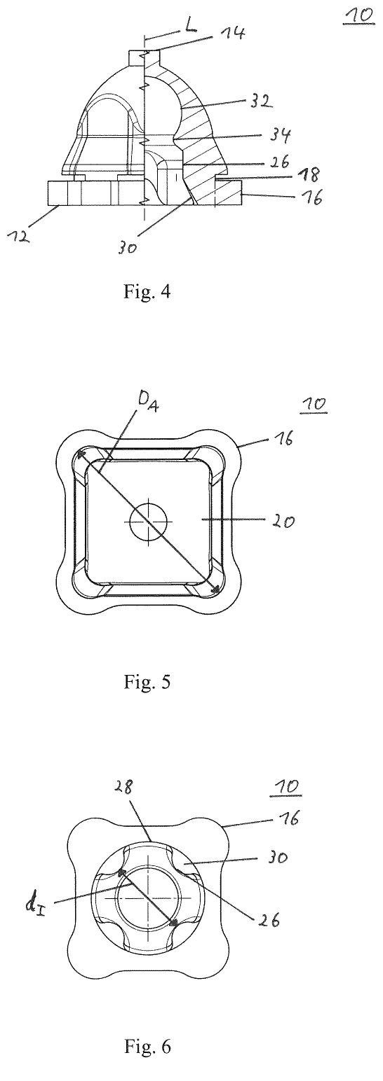

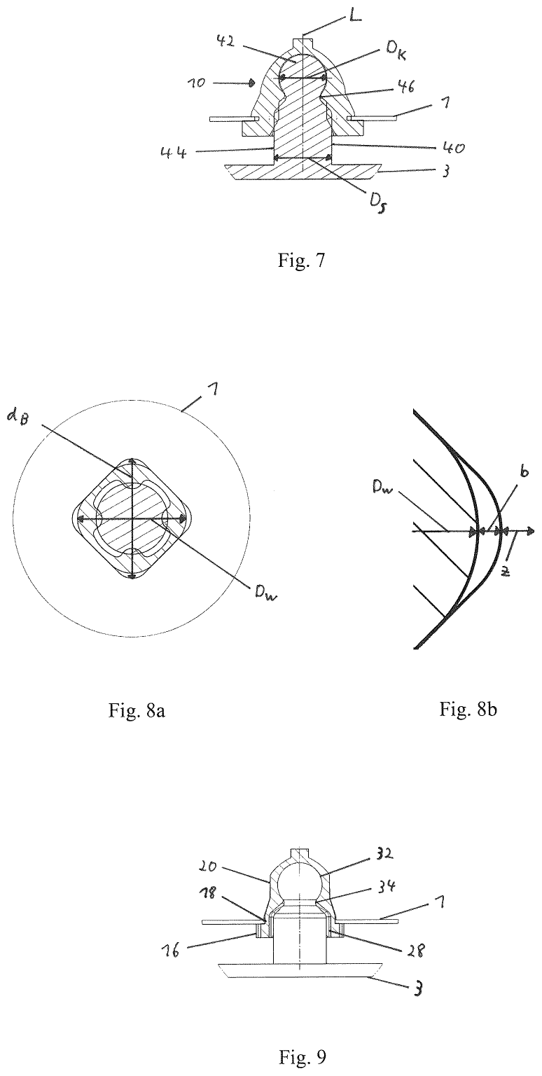

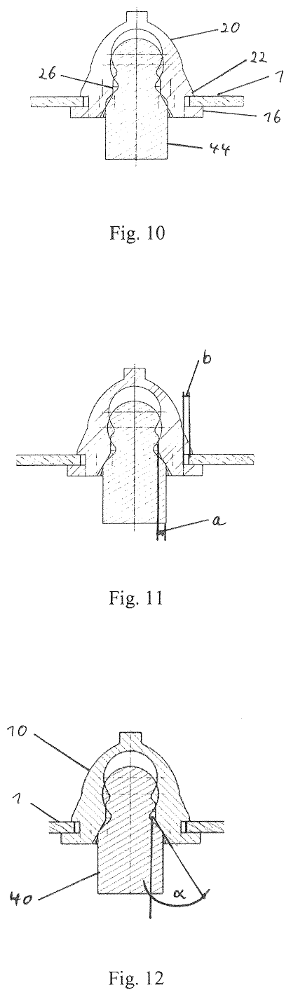

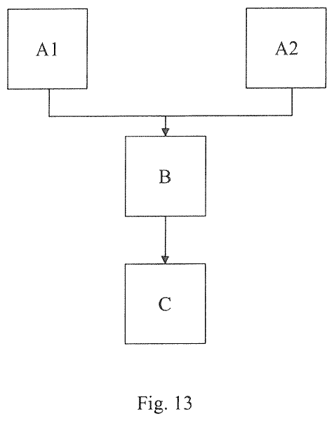

With reference to FIG. 13, an embodiment of a connecting method of the first component 1 with a polygonal component opening with a second component 3 by means of the two-part plug-in coupling is now explained. In a first step A1, a providing of the female coupling element 10 as well as an inserting of the female coupling element 10 into the polygonal component opening of the first component 1 now takes place. Alternatively, in step A2, a providing of the first component 1 with female coupling element 10 pre-assembled in there takes place.

Subsequently, in step B, a providing of a second component 3 with male coupling element 40 having a shaft 44 and a spherical head 42, which are separated by means of a tapering 46 arranged in between, takes place.

An inserting of the spherical head 42 into the female coupling element10, until the spherical head 42 is at least partly arranged in a spherical socket like receptable 32, takes place in step C. Here, the shaft 44 causes a radially outwards directed deformation movement of the female coupling element 10 in the portion of the first 22 and the second protrusions 26.
6. List of Reference Signs
1 first component
3 second component
10 female coupling element
12 first axial end
14 second axial end
16 attachment structure
18 wall
20 retaining structure
22 first protrusion
24 first recess
26 second protrusion
28 second recess
30 insertion slope
32 receptable
34 protrusion
40 male coupling element
42 spherical head
44 shaft
46 tapering
α angle of the insertion slope 30
a overlapping between shaft 44 and second protrusion 26
b gap
d_{B} inner diagonal of the component opening
d_{I} inner diagonal in the portion of the second protrusions 26
D_{A} outer diagonal in the portion of the first protrusions 22
D_{K} outer diameter of the spherical head 42
D_{S} outer diameter of the shaft 44
D_{W} outer diagonal in the portion of the wall 18
L central longitudinal axis
Z projection of the first protrusions 22

1. A female coupling element of a two-part plug-in coupling for releasably connecting a first component with polygonal component opening and a second component, wherein the female coupling element comprising:
a) a polygonal, outer, flange-like attachment structure extending in circumferential direction at an open, first axial end as well as a dome-like retaining structure with a polygonal outside having, in circumferential direction, a number of outwardly directed first protrusions and recesses being alternately arranged, wherein the retaining structure is axially spaced from the attachment structure by a wall extending in a longitudinal direction of the coupling element and circumferentially as well as
b) inside of the female coupling element adjacent to the open first axial end, in circumferential direction, a plurality of inwardly directed second protrusions and recesses being alternately arranged, wherein with respect to a central longitudinal axis (L) of the female coupling element, the second protrusions are aligned to the first protrusions, and the second protrusions comprise an axial extension of a kind that the wall in the portion of the second protrusions is thicker in comparison with the portion at the second recesses, so that
c) when inserting the female coupling element into the polygonal component opening, a material of the female coupling element is elastically compressible in circumferential direction in the portion of the first and the second recesses, so that an axial insertion force for preassembling the female coupling element in the polygonal component opening of the first component is reduced, and
d) when inserting a male coupling element with a shaft and a spherical head, the shaft of the male coupling element causes a radially outwards directed deformation movement of the female coupling element in the portion of the first and second protrusions, which are aligned to one another.

2. The female coupling element according to claim 1, wherein the attachment structure and/or the retaining structure comprises three, four, five or six corners.

3. The female coupling element according to claim 1, wherein the first protrusions are provided in each corner of the polygonal form or on each lateral face of the polygonal form.

4. The female coupling element according to claim 3, wherein
a) each first protrusion is attributed to a second protrusion (26) or
b) each first protrusion arranged on a lateral surface is attributed to a second protrusion on the inside.

5. The female coupling element according to claim 1, wherein every other protrusion comprises an insertion slope enclosing an angle with the central longitudinal axis of the coupling element between 10° and 40°.

6. The female coupling element according to claim 1, wherein when two first protrusions are arranged on opposite corners, a relation of an outer diagonal D_{A} in the portion of the first protrusions to an outer diagonal D_{W} in the portion of the wall is 1.15 D_{W}≤D_{A}≤1.2 D_{W}.

7. The female coupling element according to claim 1, wherein the female coupling element is made of one of the following materials or a combination of them: polypropylene, silicone and/or EPDM.

8. A two-part plug-in coupling with the female coupling element according to claim 1, as well as a male coupling element having a shaft and a spherical head, which are separated by means of a tapering arranged there between.

9. The two-part plug-in coupling according to claim 8, wherein an outer diameter D_{S} of the shaft is the same or larger than an outer diameter D_{K} of the spherical head, so that the following applies: D_{S}≥D_{K}.

10. The two-part plug-in coupling according to claim 8 wherein the following applies to an outer diameter D_{S} of the shaft with respect to an inner diagonal d_{I} in the portion of two second protrusions which are arranged opposite one another: 1.1 d_{I}≤D_{S}≤1.26 d_{I}.

11. A first component comprising a polygonal component opening in which a female coupling element according to claim 1 is preassembled.

12. The first component according to claim 11, wherein the following applies to an inner diagonal de of the component opening with respect to an outer diagonal D_{W} of the wall: 1.09 D_{W}≤d_{B}≤1.11 D_{W}.

13. A component structure made of the first component according to claim 11 as well as a second component with a male coupling element having a shaft and a spherical head, which are separated by means of a tapering arranged in between, wherein the spherical head is arranged at least partly in the spherical socket like receptable.

14. The component structure according to claim 13, wherein in case of a central arrangement of the female coupling element in the component opening of the first component, the following applies to the outer diameter D_{S} of the shaft with respect to a gap b, which is present between the wall of the female coupling element in the portion of the first protrusions and the component opening in a non-assembled state of the male coupling element: 11 b≤D_{S}≤15.6 b.

15. A connecting method of a first component with a polygonal component opening with a second component by means of a two-part plug-in coupling according to claim 8, the method comprising:
a1) providing the female coupling element and inserting the female coupling element into the polygonal component opening of the first component or
a2) providing the first component with the female coupling element pre-assembled in the polygonal component opening of the first component,
b) providing a second component with a male coupling element having a shaft and a spherical head which are separated by means of a tapering arranged in between, and
c) inserting the spherical head into the female coupling element until the spherical head is arranged at least partly in a spherical socket like receptable, wherein the shaft causes a radially outwards directed deformation movement of the female coupling element in the portion of the first and the second protrusions.
